(19) United States
(12) Patent Application Publication
(10) Pub. No.: US 2007/0143541 A1
(43) Pub. Date: Jun. 21, 2007

(54) Methods and structure for improved migration of raid logical volumes

(75) Inventors: Charles E. Nichols, Wichita, KS (US); William A. Hetrick, Wichita, KS (US)

Correspondence Address: LSI LOGIC CORPORATION, 1621 BARBER LANE, MS: D-106, MILPITAS, CA, 95035, US

(73) Assignee: LSI Logic Corporation

(21) Appl. No.: 11/305,992

(22) Filed: Dec. 19, 2005

(51) Int. Cl. G06F 12/16

(52) U.S. Cl. 711/114

(57) ABSTRACT

Methods and structure for improved migration of a RAID logical volume from a higher level RAID management to a lower level. Features and aspects hereof provide for migrating a RAID logical volume by removal of one or more disk drives from the logical volume and moving or regenerating only the information of the removed drive(s) that is required for the lower level of RAID storage management. In one exemplary embodiment, a RAID level 6 volume may be migrated to a RAID level 5 volume by removing a single disk drive of the volume. Minimal movement of remaining data blocks and RAID 5 parity blocks in each stripe may be performed creating new RAID level 5 stripes devoid of RAID level 6 second redundancy blocks. The newly formed RAID level 5 volume may then be mapped according to modified mapping algorithms to reduce the need for further data movement.

### RELATED APPLICATION

This patent application is related to commonly owned, co-pending, patent application Ser. No. 11/192,544 filed 30 Jul. 2005 and is related to commonly owned, co-pending patent application serial number 04-2350 filed herewith on 19 Dec. 2005, both of which are hereby incorporated by reference.

### BACKGROUND OF THE INVENTION

1. Field of the Invention

The invention relates to the methods and structures for dynamic level migration of a logical volume in a RAID storage subsystem. More specifically, the invention relates to improved methods for migrating a striped RAID volume from a higher level of redundancy to a lower level of redundancy by logically removing a disk drive from the volume.

2. Description of Related Art

Storage subsystems have evolved along with associated computing systems to improve performance, capacity, and reliability. Redundant arrays of independent disks (so called “RAID” systems) provide improved performance by utilizing striping features and provide enhanced reliability by adding redundancy information. Performance is enhanced by utilization of so called “striping” features in which one host request for reading or writing is distributed over multiple simultaneously active disk drives to thereby spread or distribute the elapsed time waiting for completion over multiple, simultaneously operable disk drives. Redundancy is accomplished in RAID systems by adding redundancy information such that the loss/failure of a single disk drive of the plurality of disk drives on which the host data and redundancy information are written will not cause loss of data. Despite the loss of a single disk drive, no data will be lost though in some instances the logical volume will operate in a degraded performance mode.

RAID storage management techniques are known to those skilled in the art by a RAID management level number. The various RAID management techniques are generally referred to as “RAID levels” and have historically been identified by a level number. RAID level 5, for example, utilizes exclusive-OR (“XOR”) parity generation and checking for such redundancy information. Whenever data is to be written to the storage subsystem, the data is “striped” or distributed over a plurality of simultaneously operable disk drives. In addition, XOR parity data (redundancy information) is generated and recorded in conjunction with the host system supplied data. In like manner, as data is read from the disk drives, striped information may be read from multiple, simultaneously operable disk drives to thereby reduce the elapsed time overhead required completing a given read request. Still further, if a single drive of the multiple independent disk drives fails, the redundancy information is utilized to continue operation of the associated logical volume containing the failed disk drive. Read operations may be completed by using remaining operable disk drives of the logical volume and computing the exclusive-OR of all blocks of a stripe that remain available to thereby re-generate the missing or lost information from the inoperable disk drive. Such RAID level 5 storage management techniques for striping and XOR parity generation and checking are well known to those of ordinary skill in the art.

RAID level 6 builds upon the structure of RAID level 5 but adds a second block of redundancy information to each stripe. The additional redundancy information is based exclusively on the data block portions of a given stripe and does not include the parity block computed in accordance with typical RAID level 5 storage management. Typically, the additional redundancy block generated and checked in RAID level 6 storage management is orthogonal to the parity generated and checked in accordance with RAID level 5 standards.

RAID level 0 is a technique that simply stripes or distributes data over a plurality of simultaneously operable disk drives of a storage subsystem. RAID level 0 provides the performance enhancements derived from such striping but is devoid of redundancy information to improve reliability. These and other RAID management levels are each useful in particular applications to improve reliability, performance or both.

It is common in such storage subsystems to logically define one or more logical volumes such that each logical volume comprises some portion of the entire capacity of the storage subsystem. Each volume may be defined to span a portion of each of one or more disk drives in the storage subsystem. Multiple such logical volumes may be defined within the storage subsystem typically under the control of a storage subsystem controller. Therefore, for any group of disk drives comprising one or more disk drives, one or more logical volumes or portions thereof may physically reside on the particular subset of disk drives.

For any number of reasons, it is common for a RAID logical volume to be migrated between two different RAID levels. For example, when the disk drives that comprise one of more logical volumes are moved from a first storage subsystem to a second storage subsystem, different RAID levels may be supported in the two subsystems. More specifically, if a first subsystem supports RAID level 6 with specialized hardware assist circuits but the second storage subsystem is largely devoid of those RAID level 6 assist circuits, the logical volumes may be migrated to a different RAID management level to permit desired levels of performance despite the loss of some reliability. Such exemplary migration may be from RAID level 6 to RAID level 5 or to RAID level 0 or from RAID level 5 to RAID level 0.

Even where a logical volume is not being physically moved between storage subsystems it may be desirable to migrate a volume from one RAID management level to another in view of changing environmental conditions or in view of changing requirements for performance and/or reliability by a host system application. Those of ordinary skill in the art will readily recognize a wide variety of reasons for such migration between RAID management levels and a variety of levels between which migration may be useful.

Presently practiced RAID migration techniques and structures perform the desired RAID level migration by moving data blocks and re-computing redundancy information to form new stripes of the new logical volume. For example, when migrating a volume from RAID level 6 to level 5, current techniques and structures form new stripes of a RAID level 5 logical volume by re-arranging data blocks and generating new XOR parity blocks to form new stripes mapped according to common mapping arrangements of RAID level 5 management. Or, for example, when migrating a volume from RAID level 6 or 5 to RAID level 0, the data blocks are re-distributed over the disk drives of the volume without any redundancy information.

These typical migration techniques may provide for optimal utilization of storage capacity of the logical volume but at a significant cost in time to move all data blocks and/or re-generate new redundancy information. Current dynamic RAID migration (“DRM”) techniques read blocks of data from the drives of the current RAID volume, recalculates new redundancy information according to the new RAID level, and writes the data and new redundancy information according to the new RAID level to the disk drives of the new logical volume. Current migration methods are time consuming, I/O intensive, and consume large amounts of memory bandwidth of the RAID controller. Current migration techniques may leave all, or major portions, of the volume inaccessible for host system request processing until completion of the migration process. It therefore remains a problem in such storage subsystems to reduce overhead processing associated with volume migration and to thereby reduce the time to migrate the volume.

### SUMMARY OF THE INVENTION

The present invention solves the above and other problems, thereby advancing the state of the useful arts, by providing improved methods and structure for the migration of RAID volumes in a RAID storage subsystem. The improved migration methods and structure reduce the overhead processing to migrate a volume and thereby complete the migration more quickly. More specifically, features and aspects hereof reduce the volume of data moved or re-generated for purposes of migrating a logical volume. In particular, features and aspects hereof provide for minimizing the movement of blocks of data and removing the need to recalculate redundancy information when migrating from a higher level of RAID to a lower level. Still more specifically, features and aspects hereof incorporate DRM methods and structures that use far less I/O, are not as demanding on memory bandwidth of the controller, and are therefore much faster than current DRM techniques.

Features and aspects hereof provide that migration performance improvement may be achieved by removing one or more drives from the RAID volume and moving or regenerating only the information from the removed drive required for the lower level of RAID management. Features and aspects hereof also allow for locking and unlocking of portions of the volume as it is migrated such that I/O processing may continue for portions not affected by the ongoing migration process.

A first feature hereof provides a method of migrating a volume of a RAID storage subsystem from a first RAID level to a second RAID level, wherein the volume comprises a plurality of disk drives (N) and wherein the volume comprises a plurality of stripes and wherein each stripe comprises a corresponding plurality of data blocks and at least a first block of corresponding redundancy information, the method comprising the steps of: reconfiguring each stripe of the plurality of stripes such that each stripe comprises the corresponding plurality of data blocks and a reduced number of blocks of corresponding redundancy information; and reducing the number of the plurality of disk drives from N, whereby the volume is migrated from the first RAID level to the second RAID level.

Another aspect hereof further provides that the first RAID level is level 6 such that each stripe includes a first block of corresponding redundancy information and a second block of corresponding redundancy information, and wherein the second RAID level is level 5, and wherein the step of reconfiguring comprises reconfiguring the plurality of stripes such that each stripe comprises the corresponding plurality of data blocks and the first block of corresponding redundancy information and wherein each stripe is devoid of the second block of redundancy information; and wherein the step of reducing comprises reducing the number of the plurality of disk drives from N to N−1.

Another aspect hereof further provides that the first RAID level is level 6 and wherein the second RAID level is level 0; and wherein the step of reconfiguring comprises reconfiguring the plurality of stripes such that each stripe contains the corresponding plurality of data blocks and is devoid of all redundancy information; and wherein the step of reducing comprises reducing the number of the plurality of disk drives from N to N−2.

Another aspect hereof further provides that the first RAID level is level 5 and wherein the second RAID level is level 0; and wherein the step of reconfiguring comprises reconfiguring the plurality of stripes such that each stripe contains the plurality of data blocks and is devoid of redundancy information; and wherein the step of reducing comprises reducing the plurality of disk drives is from N to N−1.

Another aspect hereof further provides that the step of reducing results in one or more of the plurality of disk drives of the volume being unused disk drives; and the step of reducing includes a step of releasing the unused disk drives.

Another aspect hereof further provides that the step of reconfiguring is devoid of a need to move any blocks for a subset of the plurality of stripes during reconfiguration.

Another aspect hereof further provides that each stripe of the plurality stripes is associated with a stripe identifier sequentially assigned from a sequence starting at 1 and incremented by 1; and wherein the step of reconfiguring is devoid of a need to move any blocks during reconfiguration when the stripe identifier is equal to a modulo function of N.

Another aspect hereof further provides that the step of reconfiguring is devoid of a need to move any blocks during reconfiguration when the stripe identifier is equal to a multiple of N. Another aspect hereof further provides that the step of reconfiguring needs to move at most one block for each stripe of the plurality of stripes during reconfiguration.

Another feature hereof provides a RAID storage subsystem comprising: a plurality of disk drives; a volume comprising a number of assigned disk drives (N) from the plurality of disk drives wherein the volume comprises a plurality of stripes wherein each stripe of the plurality of stripes comprises a plurality of data blocks and at least one block of redundancy information; and a storage controller coupled to the plurality of disk drives to process I/O requests received from the host system; and wherein the storage controller further comprises: a migration manager adapted to migrate the volume from a first RAID level to a second RAID level by reconfiguring each stripe to contain the plurality of data blocks and a reduced number of blocks of redundancy information; and a drive elimination manager operable responsive to the migration manager to reduce the number of assigned disk drives of the volume below N.

Another aspect hereof further provides that the drive elimination manager is adapted to eliminate one or more of the assigned disk drives to generate one or more unused disk drives and wherein the drive elimination manager is further adapted to release the unused disk drives for use by other volumes.

Another aspect hereof further provides that the first RAID level is RAID level 6 and wherein the second RAID level is RAID level 5 and wherein the drive elimination manager is adapted to eliminate one of the assigned disk drives to generate one unused disk drive and wherein the drive elimination manager is further adapted to release the unused disk drive for use by other volumes.

Another aspect hereof further provides that the first RAID level is RAID level 5 and wherein the second RAID level is RAID level 0 and wherein the drive elimination manager is adapted to eliminate one of the assigned disk drives to generate one unused disk drive and wherein the drive elimination manager is further adapted to release the unused disk drive for use by other volumes.

Another aspect hereof further provides that the first RAID level is RAID level 6 and wherein the second RAID level is RAID level 0 and wherein the drive elimination manager is adapted to eliminate two of the assigned disk drives to generate two unused disk drives and wherein the drive elimination manager is further adapted to release the unused disk drives for use by other volumes.

Another aspect hereof further provides that the reconfiguration manager is adapted to operate devoid of a need to move any of the plurality of data blocks for multiple of the plurality of stripes of the volume.

Another feature hereof provides a method operable in a storage subsystem for migrating a RAID logical volume in the subsystem from a first RAID level to a second RAID level wherein the logical volume configured in the first RAID level is striped over a plurality of disk drives and wherein each stripe has a plurality of data blocks and has wherein each stripe has at least one redundancy block, the method comprising the steps of: selecting a disk drive of the plurality of disk drive to be logically removed from the logical volume leaving a remaining set of disk drive in the logical volume; and reconfiguring each stripe of the logical volume from the first RAID level to the second RAID level by eliminating a redundancy block associated with the first RAID level in each stripe and by reorganizing remaining blocks of each stripe required for the second RAID level to reside exclusively on the remaining set disk drives.

Another aspect hereof further provides for freeing the selected disk drive for use in other logical volumes following completion of the step of reconfiguring.

Another aspect hereof further provides that the first RAID level is level 6 and wherein the second RAID level is level 5 and wherein the step of reconfiguring further comprises: eliminating a second redundancy block from each stripe and reorganizing the data blocks and first redundancy block remaining in each stripe to reside only on the remaining set of disk drives.

Another aspect hereof further provides that the first RAID level is level 5 and wherein the second RAID level is level 0 and wherein the step of reconfiguring further comprises: eliminating a redundancy block from each stripe and reorganizing the data blocks remaining in each stripe to reside only on the remaining set of disk drives.

Another aspect hereof ftrther provides that the first RAID level is level 6 and wherein the second RAID level is level 0 and wherein the step of reconfiguring further comprises: eliminating a first and second redundancy block from each stripe and reorganizing the data blocks remaining in each stripe to reside only on the remaining set of disk drives.

### BRIEF DESCRIPTION OF THE DRAWINGS

FIG. 1 is a block diagram of an exemplary storage subsystem enhanced in accordance with features and aspects hereof to improved speed of RAID level migration.

FIG. 2 is a block diagram providing additional exemplary detail of a storage controller as in FIG. 1.

FIG. 3 is a block diagram providing additional exemplary detail of a migration manager element as in FIG. 2.

FIGS. 4-8 are flowcharts describing exemplary methods in accordance with features and aspects hereof to improve the speed of RAID level migration.

FIGS. 9A and 9B depict exemplary logical volumes before and after a migration process as presently practiced in the art.

FIGS. 10 and 11 depict exemplary logical volumes after migration in accordance with features and aspects hereof.

### DETAILED DESCRIPTION OF THE DRAWINGS

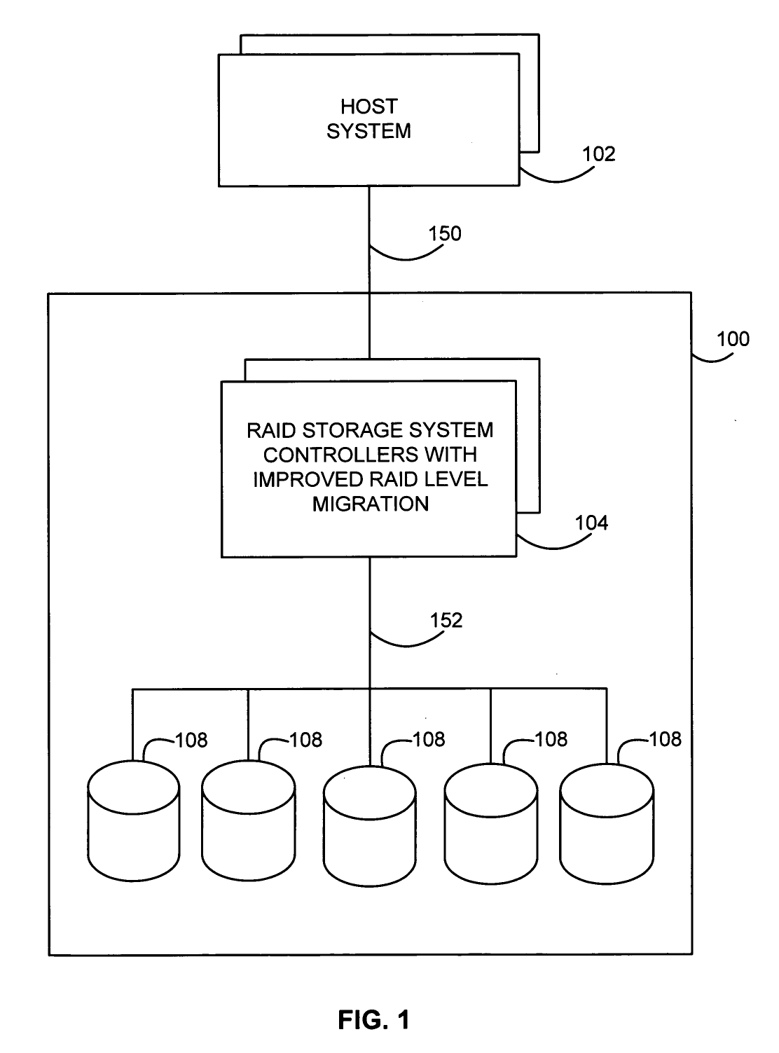

FIG. 1 is a block diagram of a storage subsystem 100 enhanced in accordance with features and aspects hereof to provide improved dynamic RAID migration capabilities. Storage subsystem 100 includes one or more RAID storage controllers 104 at least one of which is enhanced with features and aspects hereof to provide improved RAID level migration. Storage controllers 104 are adapted to couple storage subsystem 100 to one or more host systems 102 via communication path 150. Communication path 150 may be any of several well-known communication media and protocols including, for example, parallel SCSI, serial attached SCSI (“SAS”), Fibre Channel, and other well-known parallel bus and high speed serial interface media and protocols.

RAID storage controllers 104 are also coupled to a plurality of disk drives 108 via communication path 152 on which may be distributed one or more logical volumes. Path 152 may be any of several communication media and protocols similar to that of path 150. Each logical volume may be managed in accordance with any of several RAID storage management techniques referred to as RAID levels. Some common forms of RAID storage management include RAID levels 0, 5, and 6. Each RAID level provides different levels of performance enhancement and/or reliability enhancement.

As noted above, it is common for RAID storage controllers 104 to include hardware assist circuitry designed for enhancing computation and checking of redundancy information associated with some of the various common RAID levels. For example, the redundancy information generation and checking required by RAID levels 5 and 6 are often performed with the assistance of custom designed circuitry to aid in the redundancy information computation and checking as data is transferred between the host system 102 and the storage controller 104 and/or between the storage controller 104 and the plurality of disk drives 108.

As further noted above, for any of several reasons in such storage systems, it may be useful to migrate a RAID logical volume from a first level of RAID storage management to a different, lower, second level of RAID storage management. For example, if a plurality of disk drives are exported from the first storage subsystem and imported into a second storage subsystem devoid of adequate hardware assist circuitry to perform the RAID storage management features provided by the first subsystem, it may be useful to migrate the imported logical volume to a lower RAID level such that the receiving or importing storage subsystem may provide adequate performance in accessing the imported logical volume.

As further noted above, current techniques for such migration frequently involve movement of large amounts of data to reorganize the stripes the data blocks of the logical volume into newly formed stripes for the lower level of RAID storage management into which the volume is migrated. In addition, depending on the particular RAID level into which the volume is migrated, significant computation may be involved to regenerate new redundancy information in addition to the movement of data blocks. For example, when migrating a logical volume from RAID level 6 to RAID level 5, current migration techniques may generate all new stripes redistributing data blocks over the same disk drives 108 and generating required new parity blocks to be associated with each newly formed stripe of data blocks.

By contrast and as discussed further herein below, RAID storage controllers 104 of subsystem 100 are enhanced in accordance with features and aspects hereof to reduce the volume of such movement of data blocks and regeneration of required redundancy information and thus improve the speed of the migration process. In general, storage controllers 104 attempt to eliminate use of a disk dive in association with reduction of the amount of redundancy information in the change in RAID storage management levels during the migration process. By so eliminating or logically removing one of disk drives 108 from a RAID level 6 logical volume, a RAID level 5 logical volume may be formed with a significant reduction in the overhead processing for data block movement and parity regeneration. In like manner migrating from RAID level 6 to RAID level 0 may entail eliminating or logically removing two disk drives from the logical volume in association with eliminating both parity blocks of a RAID level 6 stripe. Still further, in like manner, when migrating a logical volume from RAID level 5 to RAID level 0, one disk drive of the logical volume may be eliminated or logically removed in association with eliminating the need for any redundancy information in the striped data.

By so reducing the volume of movement of data blocks and regeneration of redundancy information while migrating a logical volume, overhead processing within the RAID storage controller associated with the migration process is reduced. Elapsed time required to complete the migration process may thereby be reduced making the migrated volume fully accessible more rapidly within the receiving or importing storage subsystem.

As discussed further herein below, storage controllers 104 enhanced in accordance with features and aspects hereof may further reduce the need for movement of data blocks and/or regeneration of parity information to form new stripes by utilizing non-typical mapping functions or tables to locate blocks and associated redundancy blocks within the newly formed stripes of the migrated logical volume. Locating a particular desired logical block number in a migrated RAID logical volume may be achieved by simple arithmetic functions utilizing well-known modulo arithmetic and/or may be achieved utilizing simple table structures to physically locate a desired logical block in the newly formed stripes of the migrated logical volume.

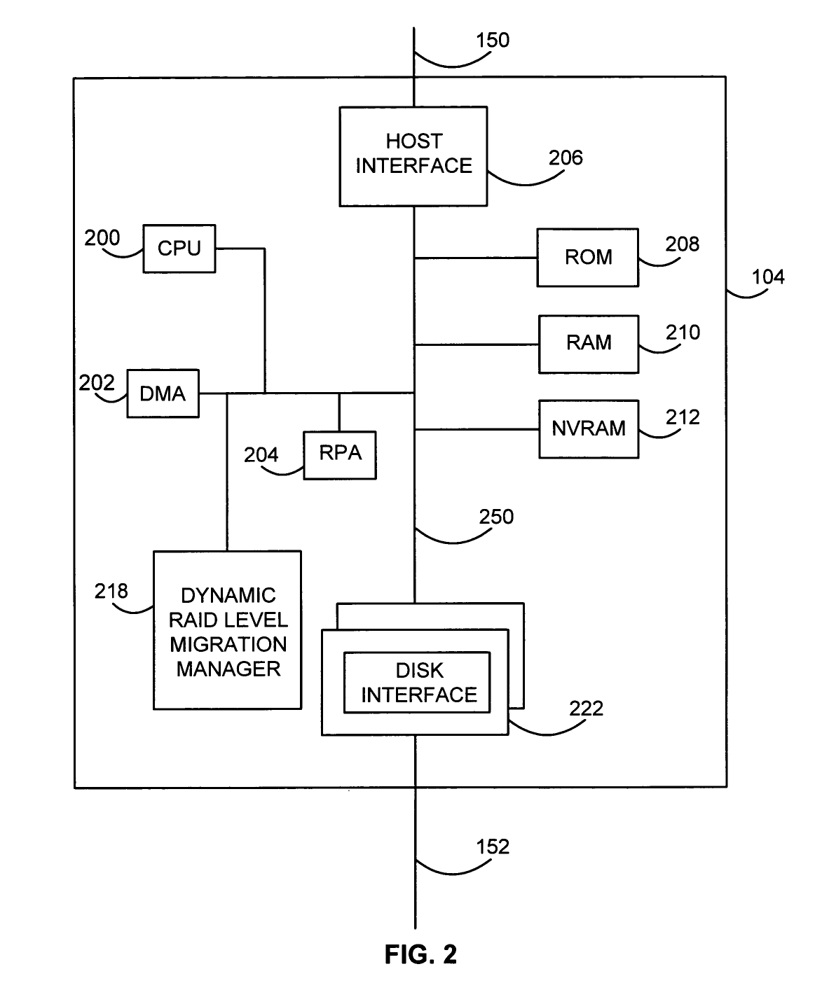

FIG. 2 is a block diagram providing additional details of an exemplary storage controller 104 enhanced in accordance with features and aspects hereof to improve RAID level migration techniques for striped RAID volumes. Exemplary RAID storage controller 104 may include a central processing unit (CPU) 200 coupled to a number of memory devices, peripheral interface devices, and processing assist circuits through processor bus 250. Bus 250 may be any of several well-known interconnecting bus media and protocols including, for example, processor architecture specific bus structures, PCI bus structures, etc. In particular, ROM 208, RAM 210, and NVRAM 212 represent a typical complement of memory devices utilized within an exemplary storage controller 104 to contain, for example, BIOS program instructions, operating program instructions, configuration parameters, buffer space, cache buffer space, and general program variable space for normal operation of storage controller 104. Host interface 206 provides adaptation of bus signals utilized by CPU 200 for protocols and communication media utilized by attached host systems. In like manner, disk interface 222 provides interface capabilities to exchange information over the processor bus 250 with appropriate signals for exchange with coupled disk drives via path 152.

As is common in most present RAID storage controllers, DMA 202 serves to improve storage controller 104 performance by offloading simple data movement processing from CPU 200 when moving data between the host interface 206, RAM 210, and disk interface 222. Further, as generally known in present storage controllers, RAID parity assist circuit 204 (“RPA”) provides hardware assist circuitry for redundancy information (e.g., parity) generation and checking as data is moved through the various control and interface elements of storage controller 104.

In accordance with features and aspects hereof, storage controller 104 is enhanced by dynamic RAID level migration manager 218 to improve performance of the migration process from a higher redundancy RAID level to a lower redundancy RAID level. In particular, features and aspects hereof provide for improvements in migrating from a striped RAID storage management level to a striped RAID storage management level providing a lower level of redundancy. For example, migrating from RAID level 6 having two redundancy blocks per stripe to RAID level S having only a single redundancy block per stripe may be improved by features and aspects hereof under control of dynamic RAID level migration manager 218 of storage controller 104. In like manner, migrating from RAID level 6 to RAID level 0 or from RAID level 5 to RAID level 0 may be improved by similar migration management features of element 218.

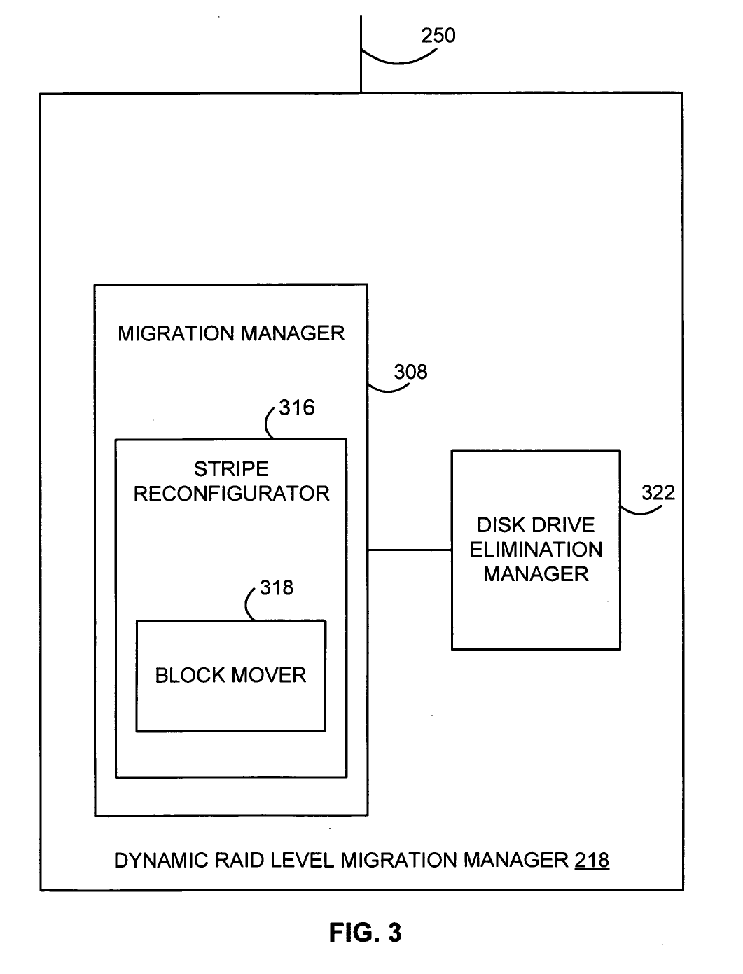

FIG. 3 is a block diagram providing additional details of an exemplary embodiment of dynamic RAID level migration manager 218. Migration manager 308 operates in conjunction with disk drive elimination manager 322 to reorganize striped data of a logical volume from a first RAID level storage management format to a second RAID level storage management format by logically removing or eliminating one or more disk drives from the plurality of disk drives that make up the logical volume. By reorganizing stripes to eliminate a disk drive from the logical volume, a significant amount of data movement and parity regeneration may be eliminated in the migration process as compared to present migration processing. Stripe reconfigurator 316 within migration manager 308 and its associated block mover element 318 are operable to reconfigure stripes of the logical volume to account for logical removal of one or more of the disk drives and in the migration of the RAID storage management level from a higher redundancy level to a lower redundancy level.

Those of ordinary skill in the art will readily recognize that a number of additional features in a typical storage subsystem 100 of FIG. 1, storage controller 104 of FIG. 2 and dynamic RAID level migration manager 218 of FIG. 3 have been removed for brevity and simplicity of this description. Additional elements and features are well known to those of ordinary skill in the art useful in a fully operation system and storage controller. Further, the particular separation or integration of elements shown in FIGS. 1-3 are matters of design choice well known to those of ordinary skill in the art. Numerous features shown separately in FIGS. 1-3 may be more tightly integrated within a single operational element or may be further or differently separated or decomposed into functional elements. Still further, those of ordinary skill in the art will recognize that numerous features of the structure shown in FIGS. 1-3 may be implemented either as appropriately programmed instructions executed in a general or special purpose processor or may be implemented as custom designed circuit as a well known matter of design choice. In particular, the RAID level migration management element 218 of FIGS. 1-3 may be implemented as suitably programmed instructions within a general or special purpose processor of the storage controller and/or may be implemented as custom designed circuits to provide a similar function. Such matters of design choice for equivalent hardware versus software implementation of various functions in such a storage controller are well known to those of ordinary skill in the art.

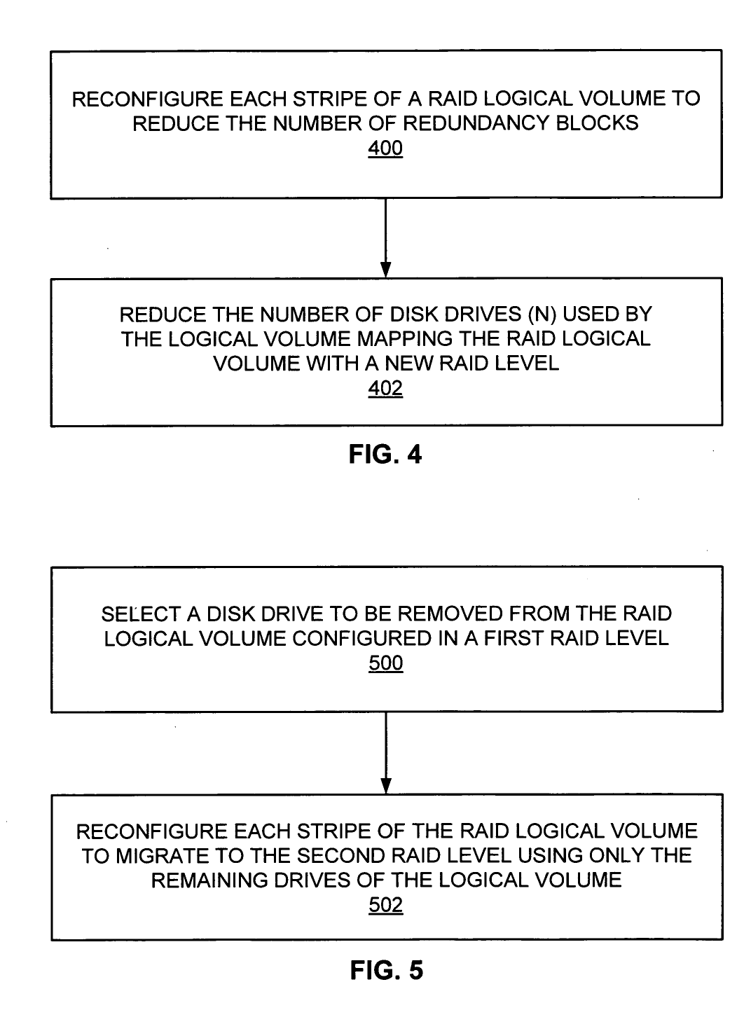

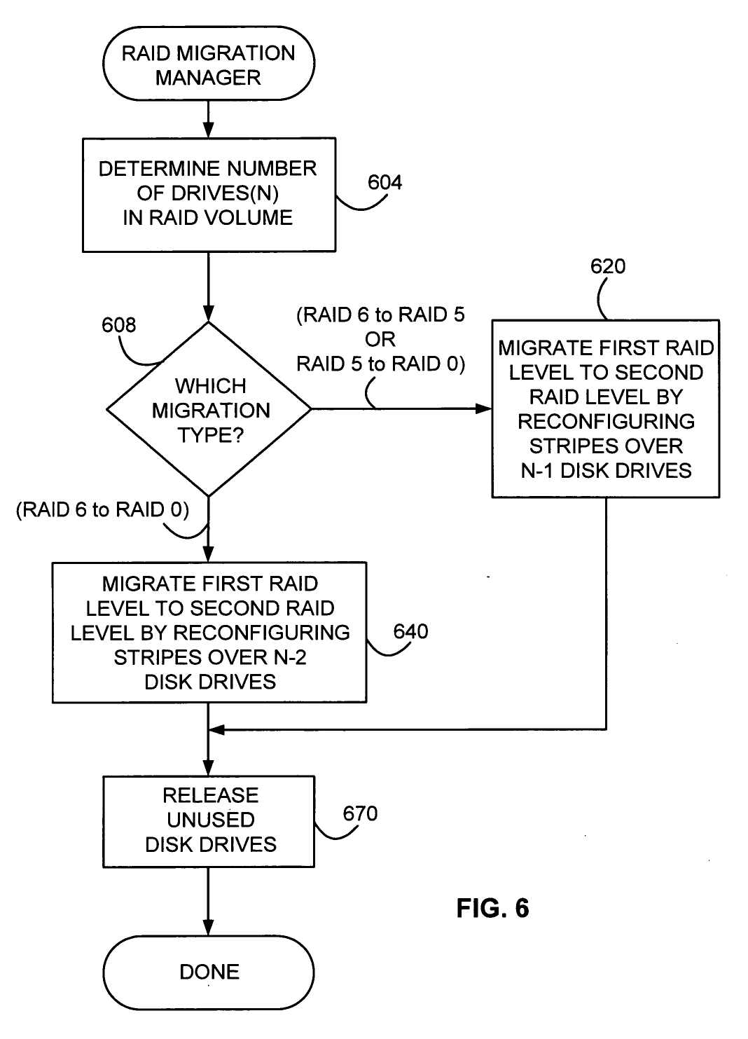

FIGS. 4 and 5 are flowcharts broadly describing methods in accordance with features and aspects hereof to improve migration of a striped RAID volume from a higher level of redundancy to a lower level of redundancy. In general, the methods of FIGS. 4 and 5 both provide for logical removal or elimination of a disk drive from a logical unit in conjunction with reducing the number of redundancy blocks associated with each stripe when migrating from a higher level of RAID redundancy to a lower level of RAID redundancy.

Element 400 of FIG. 4 is first operable to reconfigure each stripe of a RAID logical volume to reduce the number of redundancy blocks associated with each stripe of the logical volume. In the processing of element 400, data blocks and/or redundancy blocks of logical volume may be moved among the plurality of disk drives that comprise the logical volume so as to free one or more of the disk drives of the logical volume. Element 402 is then operable to reduce the number of disk drives (N) used by the logical volume mapping in accordance with the new, migrated RAID storage management level. By so reducing the number of disk drives associated with the migrated logical volume, the logically eliminated or removed disk drive(s) may be freed for use within the storage subsystem for other logical volumes or other purposes.

FIG. 5 provides another flowchart broadly describing a method in accordance with features and aspects hereof to improve migration of a RAID logical volume from a higher level of striped redundancy to a lower level of striped redundancy. Element 500 is first operable to select a disk drive to be logically removed from the RAID logical volume as configured in a first RAID level configuration. Having so identified or selected a disk drive to be logically removed from the logical volume, element 502 is then operable to reconfigure each stripe of the RAID logical volume to migrate to a second RAID level configuration such that the original data blocks and any remaining redundancy information blocks are moved only onto the remaining drives of the logical volume. The disk drive selected for logical removal may then be utilized within the storage subsystem for other logical volumes or other storage purposes.

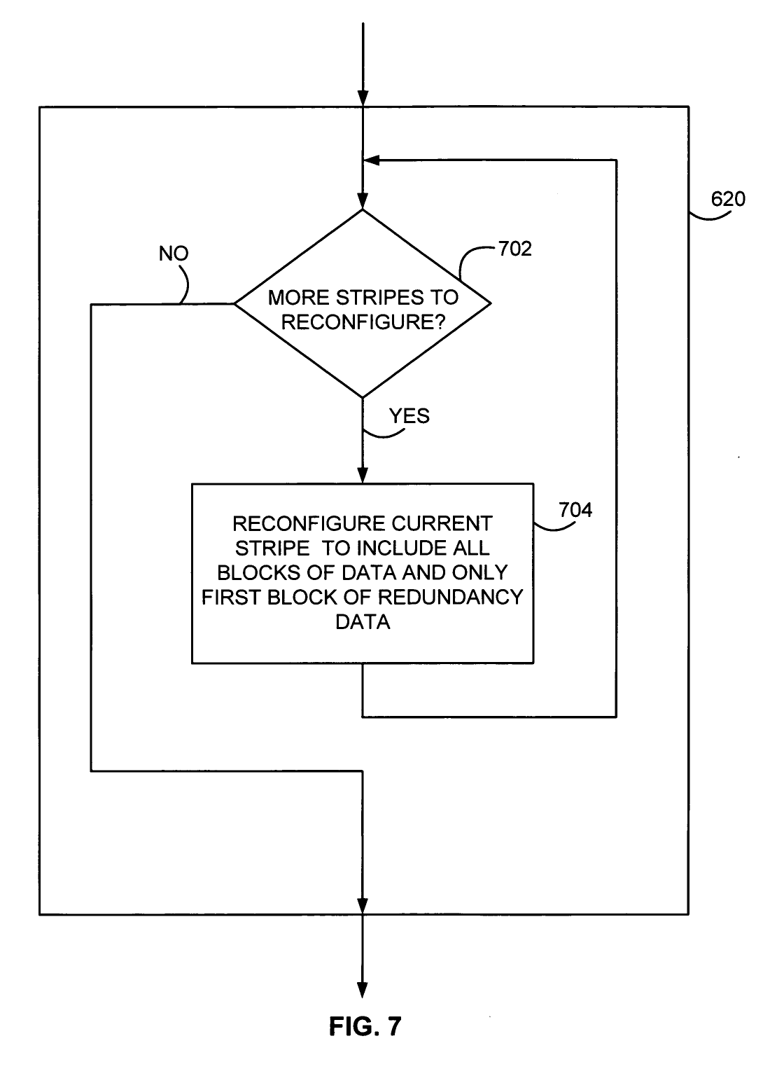

FIG. 6 is a flowchart providing additional details of an exemplary improved RAID migration manager in accordance with features and aspects hereof to migrate a striped RAID logical volume from a higher level of redundancy to a lower level of redundancy. In particular, the exemplary method of FIG. 6 is operable to migrate a RAID level 6 logical volume to a RAID level 5 logical volume, or a RAID level 5 logical volume to a RAID level 0 logical volume, or a RAID level 6 logical volume to a RAID level 0 logical volume. Element 604 is first operable to determine the number of disk drives (N) in the RAID volume as presently configured in a first RAID level configuration. Element 608 then determines which type of striped RAID volume migration has been requested. If the requested migration is from RAID level 6 to RAID level 5 or from RAID level 5 to RAID level 0, the number of disk drives may be reduced by one (logically removing or eliminating one disk drive of the volume). In such a case, element 620 is operable to perform desired migration to eliminate one disk drive from the logical volume. Otherwise, an RAID 6 to RAID 0 migration has been requested and element 640 is operable to perform a RAID level 6 to RAID level 0 migration logically eliminating two disk drives from the logical volume. In both cases, processing continues with element 670 to release the now unused disk drives for reuse within the storage subsystem for other logical volumes or other storage purposes.

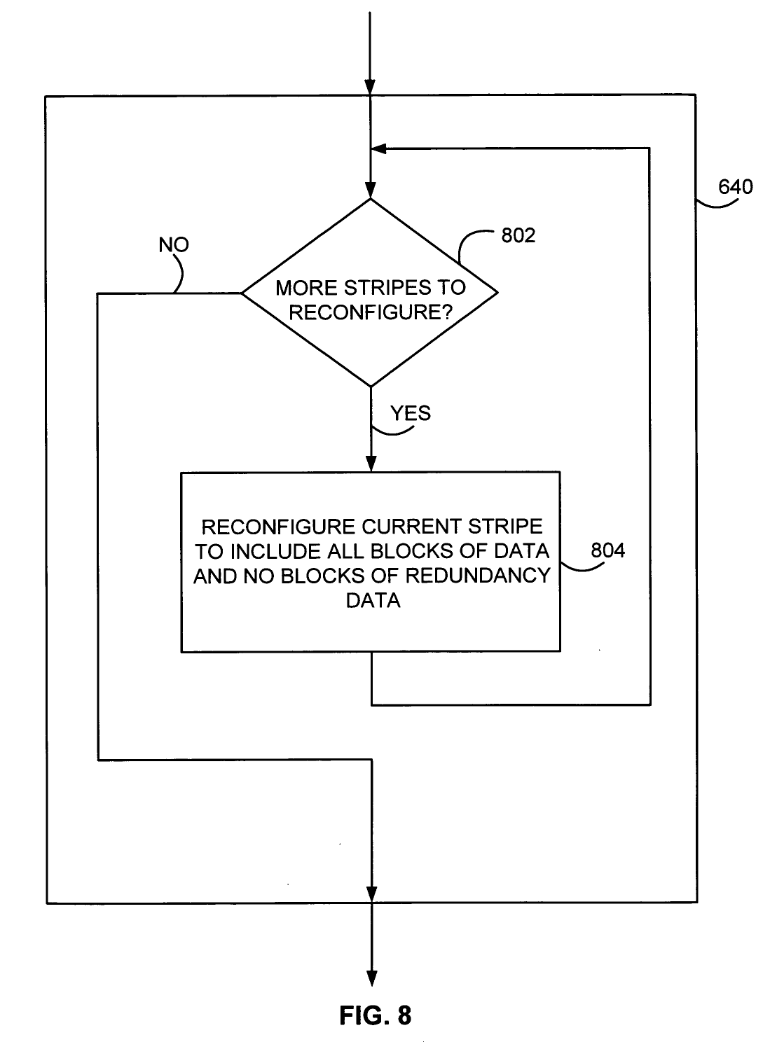

FIG. 7 is a flowchart providing additional exemplary detail for processing of element 620 of FIG. 6. Element 620 of FIG. 6 is generally operable to perform a RAID migration that logically eliminates or removes one disk drive from the logical volume. In other words, reducing the number of redundancy blocks by one in migrating from the first RAID level to the second RAID level. For example, migrating from RAID level 6 to RAID level 5 reduces the number of redundancy blocks in each stripe by one and the method of FIG. 7 allows for elimination or removal of one disk drive of from the logical volume. In like manner, migrating from RAID level 5 to RAID level 0 also eliminates one redundancy block from each stripe of logical volume thereby enabling logical removal or elimination of one disk drive from the logical volume.

As shown in FIG. 7, element 702 is first operable to determine whether more stripes remain to be reconfigured in the logical volume. If not, processing of element 620 is complete. If so, element 704 is next operable to reconfigure a next stripe to include all blocks of data from the original stripe but one less redundancy block from the original stripe. In other words, if the migration is from RAID level 6 to RAID level 5, a second redundancy block is eliminated and only the first redundancy block is maintained by the reconfiguration processing of the stripe in element 704. Similarly, if the migration is from RAID level 5 to RAID level 0, the one and only redundancy block of the original stripe is eliminated by the reconfiguration processing of element 704. Processing continues looping back to element 702 until all stripes of the logical volume have been reconfigured by processing element 704.

Those of ordinary skill in the art will recognize that the iterative processing of elements 702 and 704 may be preferably performed in a manner to lock out conflicting access to the logical volume as the stripes are being reconfigured. Such mutual exclusion locking is well known to those of ordinary skill in the art and may be performed either on the entire volume for the entire duration of the migration process or on smaller portions of the logical volume as the migration proceeds. In particular, such smaller portions may be as small as each individual stripe as it is reconfigured. Thus the processing of an I/O request may be performed by the storage controller in parallel as the migration process proceeds. All stripes but the current stripe being reconfigured may be accessed by standard I/O request processing techniques within the storage controller. In particular, stripes that have been reconfigured already may be accessed use of utilizing standard lower redundancy level RAID management techniques and hardware assist circuitry of the storage controller while stripes that have not yet been reconfigured may be manipulated by software emulation of the higher redundancy level where the storage controller is devoid of appropriate hardware assist circuitry. Such granular locking processes and associated I/O request processing are well known to those of ordinary skill and the art and need not be further discussed.

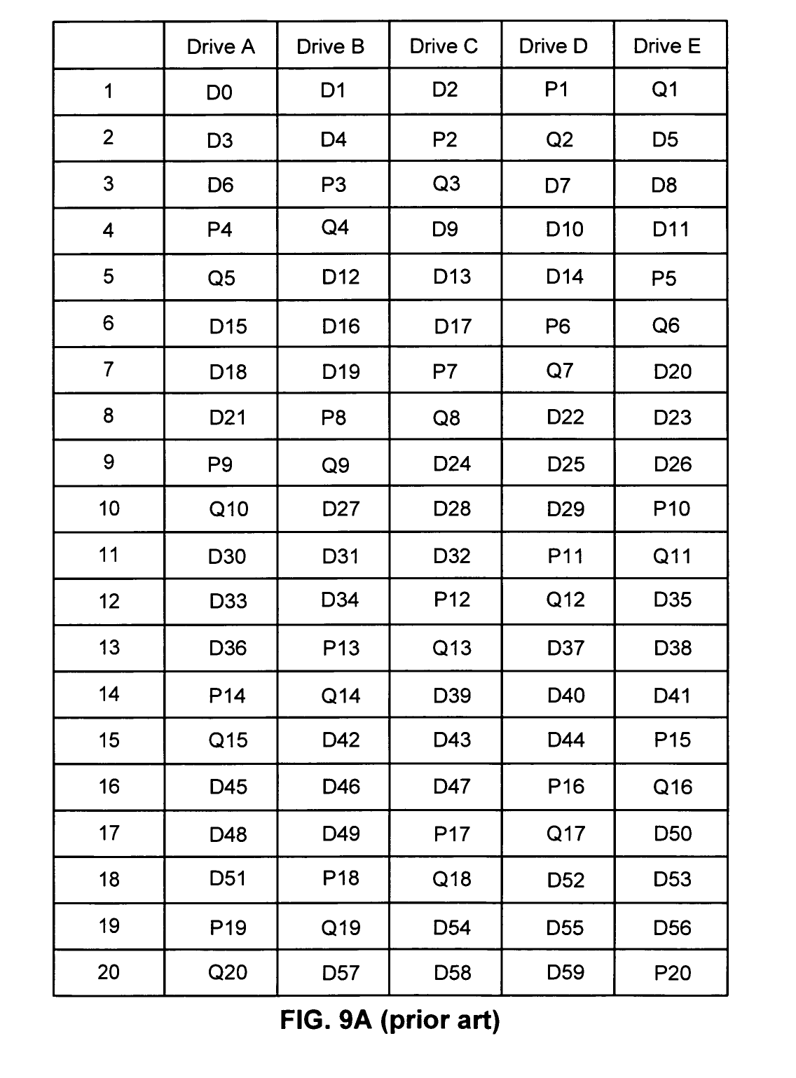

FIG. 8 is similar to FIG. 7 but provides additional exemplary detail of the processing of elements 640 of FIG. 6 to reconfigure stripes and thereby reduce the number of disk drives in the migrated logical volume by two. Element 802 is first operable to determine whether more stripes remain to be reconfigured. If not, processing of element 640 is complete. If so, element 804 is operable to reconfigure a next stripe to include all data blocks of the original stripe but neither of the original two redundancy blocks from the first RAID level 6 configuration. Thus the processing of FIG. 8 is utilized to migrate a logical volume from a first RAID level 6 format to a second RAID level 0 stripe format. Processing continues looping back to element 802 until every stripe of the logical volume has been appropriately reconfigured.

As noted above with respect to FIG. 7, appropriate locking of the entire volume or of lesser portions of the volume may be utilized to assure mutual exclusivity between the migration processing and any ongoing I/O request processing by the storage controller.

Those of ordinary skill in the art will recognize a wide variety of equivalent methods to those described above with respect to FIGS. 4-8. The methods described by FIGS. 4-8 are therefore intended merely as exemplary of possible methods providing features and aspects hereof to improve performance of RAID level migration in a RAID storage controller.

The improved migration provided by features and aspects hereof may attempt to balance two competing goals. The first goal is the reduction of data movement and parity regeneration (e.g., processing overhead) required of the migration process to thereby reduce the elapsed time that the required to migrate a logical volume from a first RAID level to a second RAID level. A second and sometimes competing goal is to maintain a typical organized format for the resulting logical volume in the second RAID level to permit simple mapping of logical blocks in the stripes of the newly formatted logical volume. In most storage controllers, simple modulo arithmetic functions may be utilized to determine the location of a logical block within the various stripes of the newly migrated logical volume. These two goals may compete in the sense that methods operable in accordance with features and aspects hereof may more dramatically reduce the volume of data movement and parity regeneration required in a migration process but at a cost that generates a new logical volume that is somewhat more difficult to map in the ongoing processing of I/O request to locate logical blocks in the newly formatted stripes. However, slightly more complex modulo arithmetic and/or at the logical to physical block location mapping table structures may be utilized as well known to those of ordinary skill and the art to maintain adequate performance in processing of I/O requests on the newly formatted logical volume.

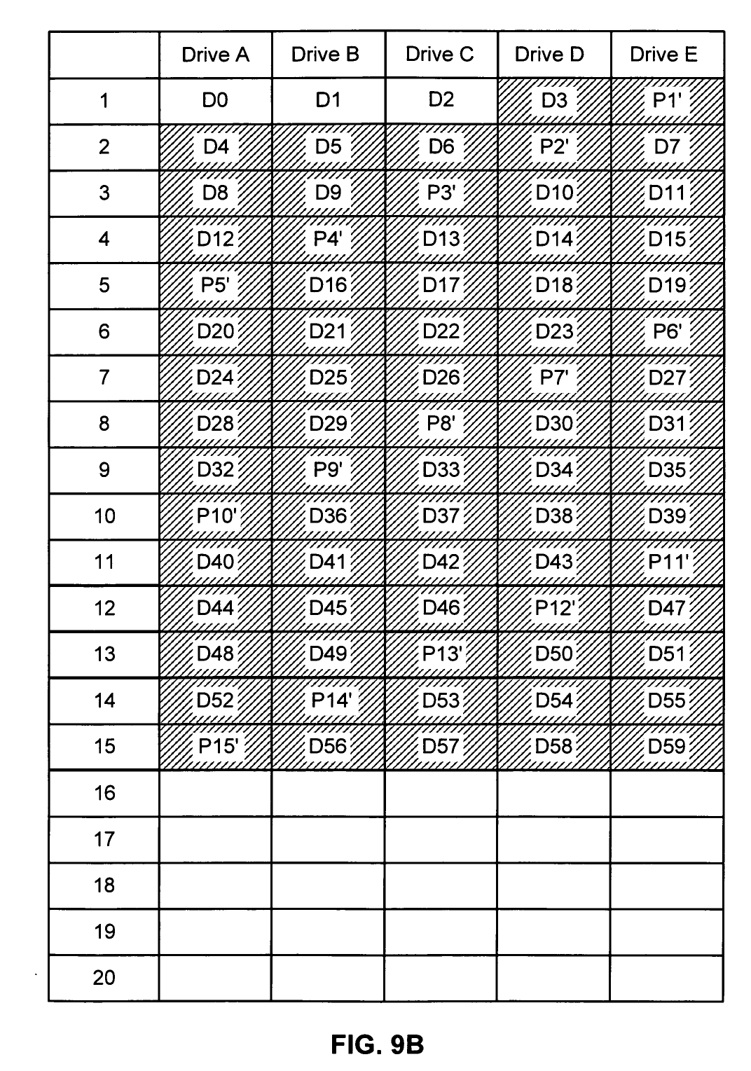

Before noting exemplary improved migration techniques and mappings in accordance with features and aspects hereof, it is worth noting the amount of data movement and parity generation required by present migration techniques. FIG. 9A is a diagram of an exemplary RAID level 6 logical volume comprising 20 stripes (labeled in rows 1-20) and 5 disk drives (labeled in columns A-E). A typical mapping of a RAID level 6 logical volume (with 5 disk drives) maps 3 data blocks with a first and second redundancy block into each stripe (5 blocks per stripe—one per disk drive A-E). For example, stripe 1 of FIG. 9A shows data blocks D0-D2 on drives A-C, respectively, first redundancy block P1 on drive D and second redundancy block Q1 on drive E. The data and redundancy block positions are rotated in each successive stripe in a typical RAID level 6 mapping of blocks. Thus, for example, stripe 2 of FIG. 9A shows data blocks D3-D5 on drives A, B, and E, respectively, with first redundancy block P1 on drive C and second redundancy block Q1 on drive D and stripe 3 of FIG. 9A shows data blocks D6-D8 on drives A, D, and E, respectively, with first redundancy block P1 on drive B and second redundancy block Q1 on drive C, etc.

As presently practiced in the art, a migration from RAID 6 to RAID 5 without logically removing a drive of the plurality of disk drive would simply remove all the second redundancy blocks (Q1 . . . Q20 of FIG. 9A) and shift all other data blocks up such that each newly formed RAID level 5 stripe would comprise four consecutive data blocks plus a corresponding newly generated parity redundancy block (P1 . . . PX where X is the reduced number of stripes in the migrated logical volume). FIG. 9B shows such an exemplary RAID level 5 logical volume migrated in accordance with presently known techniques from the exemplary RAID level 6 logical volume of FIG. 9A. Thus, as presently practiced, migration from RAID level 6 to RAID level 5 without logically removing a disk drive would read every data block of the volume, re-write all read data blocks but the first 3 (in the exemplary 5 drive logical volume), and recompute and write new parity blocks to thereby generate all new stripes for the newly migrated logical volume. The number of blocks written in this migration is depicted graphically in FIG. 9B as shaded blocks. The newly computed parity blocks are designated P1′ . . . P15′. This large volume of reading of data blocks, writing of data blocks, and redundancy data computation requires significant overhead processing in the present storage controller and hence a significant time to complete the migration process.

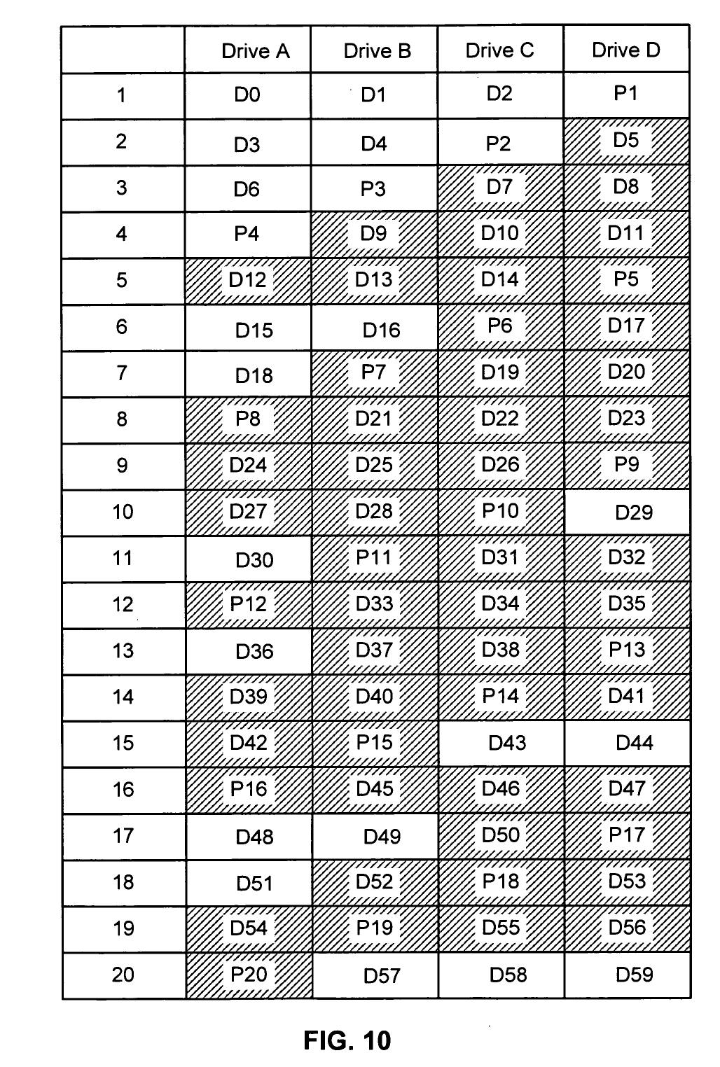

Features and aspects hereof reduce this volume of data block movement (reading and re-writing in a new stripe location) and eliminate the need to recompute any redundancy information blocks by logically removing one drive from the logical volume. FIG. 10 shows an exemplary newly formed RAID level 5 logical volume formed in accordance with features and aspects hereof by improved migration of the RAID level 6 logical volume of FIG. 9A. In particular, the exemplary volume of FIG. 10 has logically removed or eliminated drive E of the volume. The second redundancy blocks (Q1 . . . Q20) of the RAID level 6 logical volume of FIG. 9A have been eliminated from the migrated volume. Data blocks and parity blocks that had resided on the logically removed drive E are moved to new locations in stripes 1 . . . 20 of the RAID level 5 logical volume. The data and parity blocks moved are indicated graphically as shaded blocks in FIG. 10.

Comparing the overhead processing of presently practiced migration processing that generates the volume of FIG. 9B and the exemplary implementation of features and aspects hereof that generate the exemplary volume of FIG. 10 shows a dramatic decrease in overhead processing and thus in the elapsed time required to perform the migration. In particular, the migration as presently practiced and represented by the volume of FIG. 9B requires that every data block is read (60 block reads), all but 3 data blocks are re-written in new stripe positions (57 block writes), and 15 new parity blocks are generated and written (15 stripe parity computations and 15 block writes). The overhead processing represented by the exemplary volume of FIG. 10 formed in accordance with improved features and aspects hereof reads and re-writes 56 total blocks including data blocks moved and parity blocks moved (e.g., 56 block reads and 56 block writes). Since the data blocks protected by the parity blocks P1 . . . P20 are unchanged so to the parity blocks are unchanged. Features and aspects hereof permit migration from RAID level 6 to level 5 without the need to regenerate any RAID level 5 parity blocks.

It will be noted that the logical volume of FIG. 10 is formed in accordance with typical RAID level S mapping of blocks to stripes. As noted above, the data blocks are distributed sequentially over the drives with the parity blocks rotating positions in each stripe. This typical mapping allows simple modulo arithmetic computations to determine the physical location of any desired block. However, with slightly more complex mapping techniques such as slight complications in the modulo arithmetic functions or use of mapping tables rather than arithmetic computations to locate physical blocks, the overhead processing for the migration may be even more dramatically reduced.

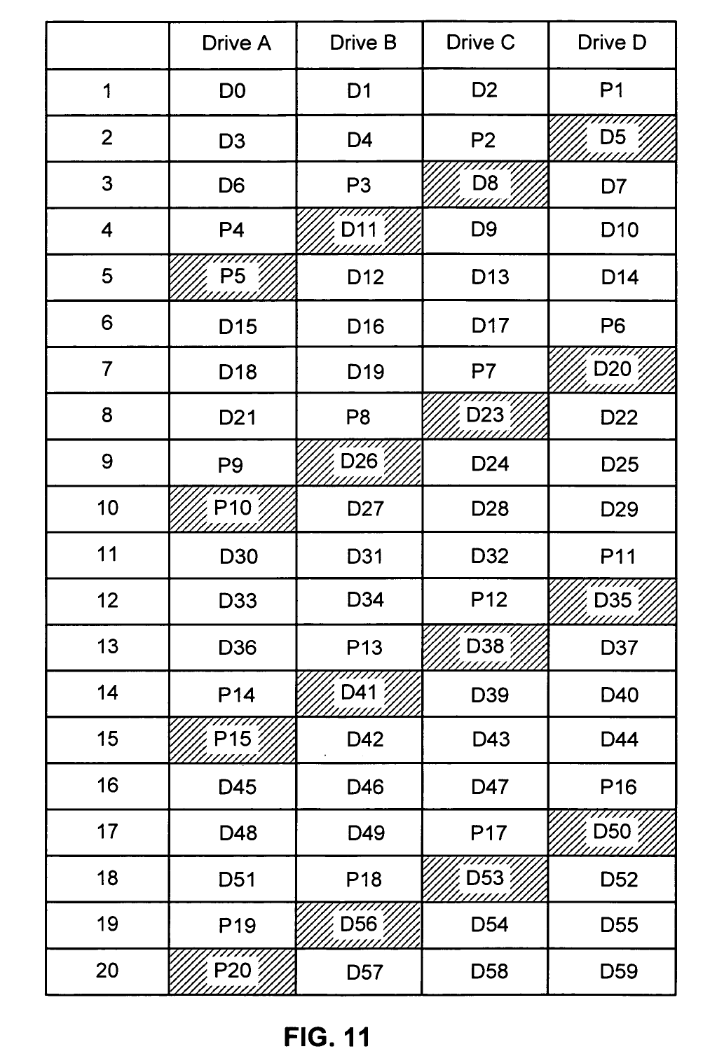

FIG. 11 is another exemplary RAID level 5 logical volume formed by migrating the level 6 volume of FIG. 9A in accordance with features and aspects hereof. In accordance with this aspect, any data or parity block that resided on the logically removed disk drive (drive E of FIG. 9A) is simply moved to the location of the stripe'ss second redundancy block (Q1 . . . Q20) that is no longer required in the migrated RAID level 5 format. Though the resulting volume does not organize the blocks of each stripe in typical RAID level 5 sequence, slight additional modulo arithmetic computations or table oriented mapping techniques may be employed to locate physical blocks in the exemplary migrated logical volume represented by FIG. 11. Such enhanced mapping techniques are well known to those of ordinary skill in the art and need not be further discussed herein.

Though the mapping of physical block locations may be more complex, the migration overhead processing is even more dramatically increased as compared to present migration techniques. In the exemplary migrated logical volume of FIG. 11, only 20 blocks are moved (indicated graphically as shaded blocks). A mere 20 block reads and block writes are required to complete the migration process. Again, as above in FIG. 10, no parity block regeneration is required in this exemplary migration. Thus the migrated volume is ready for full and optimal access more quickly than under present migration techniques.

Those of ordinary skill in the art will recognize that a pattern of block movements arises from the migrations processes and structures in accordance with features and aspects hereof. For example, the migration exemplified by the block movements of FIG. 10 repeat every 20 stripes. The movements of blocks in the migration exemplified by FIG. 11 repeat every 5 blocks. At most, such a pattern of block movements will arise in at most N*(N−1) stripes where one disk drive is logically removed and in at most N*(N31 2) stripes where two disk drives are logically removed from the volume. That same pattern may be advantageously applied to the more complex the mapping required where the resulting migrated volume positions blocks in stripes different than the typical sequential ordering (such as shown in FIG. 11). A mapping table may be used to locate logical blocks but the table need only map logical block offsets in the repeating pattern of stripes. For example, in the migrated volume of FIG. 11 a mapping table need only map the block locations of 5 stripes since the patter repeats every 5 stripes. Simple modulo arithmetic may be used to add a bias offset to the logical block number positioning derived from such a simplified mapping table. These and other mapping simplifications based on the repeating pattern of block movement in the volume translation will be readily apparent to those of ordinary skill in the art.

Those of ordinary skill in the art will readily recognize numerous other block movement patterns that result in overhead processing savings in accordance with features and aspects hereof where one or more disk drives of the volume are logically removed or eliminated to speed the migration process. Corresponding mapping computations and/or tables will also be readily apparent to those of ordinary skill in the art to permit rapid location of physical blocks corresponding to desired logical block numbers.

Figures similar to FIGS. 10 and 11 may represent the migration of a RAID level 5 logical volume to a RAID level 0 logical volume where all data blocks are migrated and the parity blocks are discarded in the process of logically removing one disk drive from the migrated logical volume. Still further, those of ordinary skill in the art will readily recognize similar exemplary volume migrations such as from a RAID level 6 volume to a RAID level 0 volume where 2 disk drives may be logically removed to speed the migration process.

While the invention has been illustrated and described in the drawings and foregoing description, such illustration and description is to be considered as exemplary and not restrictive in character. One embodiment of the invention and minor variants thereof have been shown and described. Protection is desired for all changes and modifications that come within the spirit of the invention. Those skilled in the art will appreciate variations of the above-described embodiments that fall within the scope of the invention. As a result, the invention is not limited to the specific examples and illustrations discussed above, but only by the following claims and their equivalents.

What is claimed is:

1. A method of migrating a volume of a RAID storage subsystem from a first RAID level to a second RAID level, wherein said volume comprises a plurality of disk drives (N) and wherein said volume comprises a plurality of stripes and wherein each stripe comprises a corresponding plurality of data blocks and at least a first block of corresponding redundancy information, the method comprising the steps of:
reconfiguring each stripe of said plurality of stripes such that said each stripe comprises said corresponding plurality of data blocks and a reduced number of blocks of corresponding redundancy information; and
reducing the number of said plurality of disk drives from N,
whereby the volume is migrated from said first RAID level to said second RAID level.

2. The method of claim 1
wherein said first RAID level is level 6 such that said each stripe includes a first block of corresponding redundancy information and a second block of corresponding redundancy information, and
wherein said second RAID level is level 5, and
wherein the step of reconfiguring comprises reconfiguring said plurality of stripes such that said each stripe comprises said corresponding plurality of data blocks and said first block of corresponding redundancy information and wherein said each stripe is devoid of said second block of redundancy information; and
wherein the step of reducing comprises reducing the number of said plurality of disk drives from N to N−1.

3. The method of claim 1
wherein said first RAID level is level 6 and wherein said second RAID level is level 0; and
wherein the step of reconfiguring comprises reconfiguring said plurality of stripes such that said each stripe contains said corresponding plurality of data blocks and is devoid of all redundancy information; and
wherein the step of reducing comprises reducing the number of said plurality of disk drives from N to N−2.

4. The method of claim 1
wherein said first RAID level is level 5 and wherein said second RAID level is level 0; and
wherein the step of reconfiguring comprises reconfiguring said plurality of stripes such that each stripe contains said plurality of data blocks and is devoid of redundancy information; and
wherein the step of reducing comprises reducing said plurality of disk drives is from N toN−1.

5. The method of claim 1
wherein the step of reducing results in one or more of said plurality of disk drives of the volume being unused disk drives; and
the step of reducing includes a step of releasing said unused disk drives.

6. The method of claim 1
wherein the step of reconfiguring is devoid of a need to move any blocks for a subset of said plurality of stripes during reconfiguration.

7. The method of claim 1
wherein each stripe of said plurality stripes is associated with a stripe identifier sequentially assigned from a sequence starting at 1 and incremented by 1; and
wherein the step of reconfiguring is devoid of a need to move any blocks during reconfiguration when said stripe identifier is equal to a modulo finction of N.

8. The method of claim 7
wherein the step of reconfiguring is devoid of a need to move any blocks during reconfiguration when the stripe identifier is equal to a multiple of N.

9. The method of claim 1
wherein the step of reconfiguring needs to move at most one block for each stripe of said plurality of stripes during reconfiguration.

10. A RAID storage subsystem comprising:
a plurality of disk drives;
a volume comprising a number of assigned disk drives (N) from said plurality of disk drives wherein said volume comprises a plurality of stripes wherein each stripe of said plurality of stripes comprises a plurality of data blocks and at least one block of redundancy information; and
a storage controller coupled to said plurality of disk drives to process I/O requests received from said host system; and
wherein the storage controller further comprises:
a migration manager adapted to migrate the volume from a first RAID level to a second RAID level by reconfiguring said each stripe to contain said plurality of data blocks and a reduced number of blocks of redundancy information; and
a drive elimination manager operable responsive to said migration manager to reduce said number of assigned disk drives of the volume below N.

11. The system of claim 10 wherein said drive elimination is adapted to eliminate one or more of said assigned disk drives to generate one or more unused disk drives and wherein said drive elimination manager is further adapted to release said unused disk drives for use by other volumes.

12. The system of claim 10 wherein said first RAID level is RAID level 6 and wherein said second RAID level is RAID level 5 and
wherein said drive elimination is adapted to eliminate one of said assigned disk drives to generate one unused disk drive and wherein said drive elimination manager is further adapted to release said unused disk drive for use by other volumes.

13. The system of claim 10 wherein said first RAID level is RAID level 5 and wherein said second RAID level is RAID level 0 and
wherein said drive elimination is adapted to eliminate one of said assigned disk drives to generate one unused disk drive and wherein said drive elimination manager is further adapted to release said unused disk drive for use by other volumes.

14. The system of claim 10 wherein said first RAID level is RAID level 6 and wherein said second RAID level is RAID level 0 and
wherein said drive elimination is adapted to eliminate two of said assigned disk drives to generate two unused disk drives and wherein said drive elimination manager is further adapted to release said unused disk drives for use by other volumes.

15. The system of claim 10 wherein said reconfiguration manager is adapted to operate devoid of a need to move any of the plurality of data blocks for multiple of the plurality of stripes of the volume.

16. A method operable in a storage subsystem for migrating a RAID logical volume in the subsystem from a first RAID level to a second RAID level wherein the logical volume configured in the first RAID level is striped over a plurality of disk drives and wherein each stripe has a plurality of data blocks and has wherein each stripe has at least one redundancy block, the method comprising the steps of:
selecting a disk drive of the plurality of disk drive to be logically removed from the logical volume leaving a remaining set of disk drive in the logical volume; and
reconfiguring each stripe of the logical volume from the first RAID level to the second RAID level by eliminating a redundancy block associated with the first RAID level in said each stripe and by reorganizing remaining blocks of said each stripe required for the second RAID level to reside exclusively on the remaining set disk drives.

17. The method of claim 16 further comprising:
freeing the selected disk drive for use in other logical volumes following completion of the step of reconfiguring.

18. The method of claim 16 wherein the first RAID level is level 6 and wherein the second RAID level is level 5 and wherein the step of reconfiguring further comprises:
eliminating a second redundancy block from said each stripe and reorganizing the data blocks and first redundancy block remaining in said each stripe to reside only on the remaining set of disk drives.

19. The method of claim 16 wherein the first RAID level is level 5 and wherein the second RAID level is level 0 and wherein the step of reconfiguring further comprises:
eliminating a redundancy block from said each stripe and reorganizing the data blocks remaining in said each stripe to reside only on the remaining set of disk drives.

20. The method of claim 16 wherein the first RAID level is level 6 and wherein the second RAID level is level 0 and wherein the step of reconfiguring further comprises:
eliminating a first and second redundancy block from said each stripe and reorganizing the data blocks remaining in said each stripe to reside only on the remaining set of disk drives.
